(19) United States
(12) Patent Application Publication
(10) Pub. No.: US 2005/0106300 A1
(43) Pub. Date: May 19, 2005

(54) Method for producing a material having an increased solubility in alcohol

(75) Inventors: Li-Fu Chen, West Lafayette, IN (US); Qin Xu, West Lafayette, IN (US); Bruce R. Hamaker, West Lafayette, IN (US)

Correspondence Address: Kristin Davenport, P.O. Box 770, Richard, MI, 49083, US

(73) Assignee: Purdue Research Foundation

(21) Appl. No.: 10/880,970

(22) Filed: Jun. 30, 2004

Related U.S. Application Data
(60) Provisional application No. 60/483,724, filed on Jun. 30, 2003.

(51) Int. Cl. A23P 1/00

(52) U.S. Cl. 426/490

(57) ABSTRACT

A method of processing a starchy plant material to produce a processed material having an increased solubility in alcohol comprising mixing the starchy plant material and a liquid at an elevated temperature to form a mixture and applying shear force to the mixture to produce the processed material. The processed material is one or more or a combination or complex of protein, zein, and oil.

This application claims the benefits and priority of U.S. provisional application Ser. No. 60/483,724 filed Jun. 30, 2003.

### BACKGROUND OF THE INVENTION

1. Field of the Invention

The present invention relates to a method of processing a starchy plant material to produce a processed material having an increased solubility in alcohol comprising mixing the starchy plant material and a liquid at an elevated temperature to form a mixture and applying shear force to the mixture to produce the processed material.

2. Description of Related Art

Corn or other starchy plant materials are commonly converted to economical or nutritious products. Dry milling and wet milling are two types of corn processing methods currently used in the industry. Wet milling process produces highly valuable products such as corn oil and starch. Other wet milling products are corn gluten meal, corn gluten feed and corn steep liquor. However, wet milling is expensive due to the large investments in machinery and operating cost. Also, due to a steeping process being involved in the wet milling process, the protein in gluten meal is not edible and can only be used for animal feed. Moreover, the steeping of the corn kernels takes several days. Dry milling is used to produce corn meal and feeds. Dry grind method is used to produce ethanol with distillers grain as a by-product and is used for animal feed.

To improve the production economics of corn products for food or non-food uses, several approaches can be taken: the corn products can be converted to value added materials, such as producing food grade corn protein and fiber; by simplifying the corn processing; and by increasing the yield of each product such as corn oil, starch, and corn protein.

Corn protein consists of two major fractions. One fraction is prolamine in nature and is soluble in alcohols. In corn, this fraction is called “zein”; the other fraction of corn protein is albumin and globulins that are soluble in water and salt solutions.

In the early 1950s, researchers developed zein as a polymeric substrate for films and fibers (blended with wool). It had potential to become a widely used material; however, this potential has not been realized because zein production was too expensive to compete with nylon and polyester. Zein can be extracted with aqueous alcohol and dried to a granular powder; however, the isolation of zein is expensive because the isolation process requires the use of a large quantity of alcohol. Currently, since the cornstarch used to produce ethanol does not have to be especially pure, new research in zein separation processing aims for low cost, rather than high zein purity or thoroughness of recovery. This opens up a new window of opportunity for using mechanical separation methods.

Additionally, purified zein dissolves in aqueous-ethanol solution with ethanol concentration ranging from 60 to 80%. The solubility can be as high as 0.1 g per milliliter. Zein in its natural state is soluble in aqueous ethanol containing 60 to 80% ethanol and is insoluble in absolute ethanol. A portion of zein in ground corn (approximately one third of the zein protein) becomes soluble in ethanol having a concentration ranging from 95 to 100%. Zein extraction is expensive because the extraction uses a large amount of ethanol due to the low solubility of zein in ethanol. To reduce the cost of solvent recovery, U.S. Pat. No. 6,433,146 teaches the technique of ultrafiltration or nanofiltration to separate oil and protein after zein and oil were extracted with 90% to 100% ethanol. If necessary, the residual zein in corn can be further extracted by 60% to 90% ethanol. This procedure is disadvantageous in that most of the zein remains in a natural state that is only soluble in 70%-80% ethanol and a large quantity of ethanol is needed to extract the oil and protein.

An object of the present invention is to provide an improved method of making a processed material from a starchy plant material wherein the processed material has an increased solubility in alcohol and is thermoplastic and where the method overcomes the disadvantages of traditional processing.

### SUMMARY OF THE INVENTION

An embodiment of the invention involves a method of processing starchy plant material to produce a processed material having an increased solubility in alcohol comprising mixing the starchy plant material and a liquid at an elevated temperature to form a mixture and applying shear force to the mixture to produce the processed material. The processed material comprises a protein and /or a combination of protein and oil and is thermoplastic.

In an embodiment of the invention, the starchy plant material preferably is selected from the group consisting of corn kernel, corn meals, distillers grain, sorghum, and millet. The liquid can be a plasticizer, such as water, and is added to a achieve a moisture content in the range of about 10 to 70% w/w of the mixture. A liquefaction enzyme, such as alpha-amylase, can be mixed with the starchy plant material and the liquid. The elevated temperature can be in a range from about 80° C. to 150° C.

The mixture is then dried to a moisture content less than 15% w/w. The mixing, application of shear force, and drying preferably occur in a high shear processor.

The processed material is then extracted from the mixture with an extractant, such as ethanol that is 90 to 100% w/w ethanol balance water. The extractant is in a temperature range of about 50° C. to boiling temperature of the extractant. Starch remains as a byproduct of the extraction and the starch is converted to corn syrup.

After the extraction, some of the oil is then separated from the processed material. Then the processed material and a solvent are contacted to remove any residual oil.

In an alternate embodiment of the invention the mixture is dried to a moisture content less than 3% w/w, and then undergoes extraction to remove the processed material from the mixture in the presence of alcohol while dehydrating the alcohol.

### DESCRIPTION OF DRAWINGS

FIG. 1 is a flow chart which may be used in accordance with an illustrative embodiment of the present invention.

FIG. 2 is a table showing the elution pattern of corn oil and protein.

### DETAILED DESCRIPTION OF THE INVENTION

The invention is especially useful in corn processing but is not limited thereto as other kinds of starchy plant materials such as corn meals, distillers grain (DDG) from brewing and other fermentation processes, sorghum and millet can be processed by the present invention. The starchy plant material may also be a whole grain, isolated protein, or partially isolated protein.

An embodiment of this invention provides a method that employs a liquid as a plasticizer, elevated temperature (superambient), and shear force to produce a processed material having increased solubility in alcohol and is thermoplastic. This invention can be practiced to produce an oil.

The processed material comprises protein, zein, and/or combinations of protein and/or zein with an oil. Thermoplastic is defined as a material capable of becoming soft when heated and rigid when cooled. The material resulting from this invention is food grade, which means fit for consumption by a human, and biodegradable, which means capable of being decomposed by biological agents.

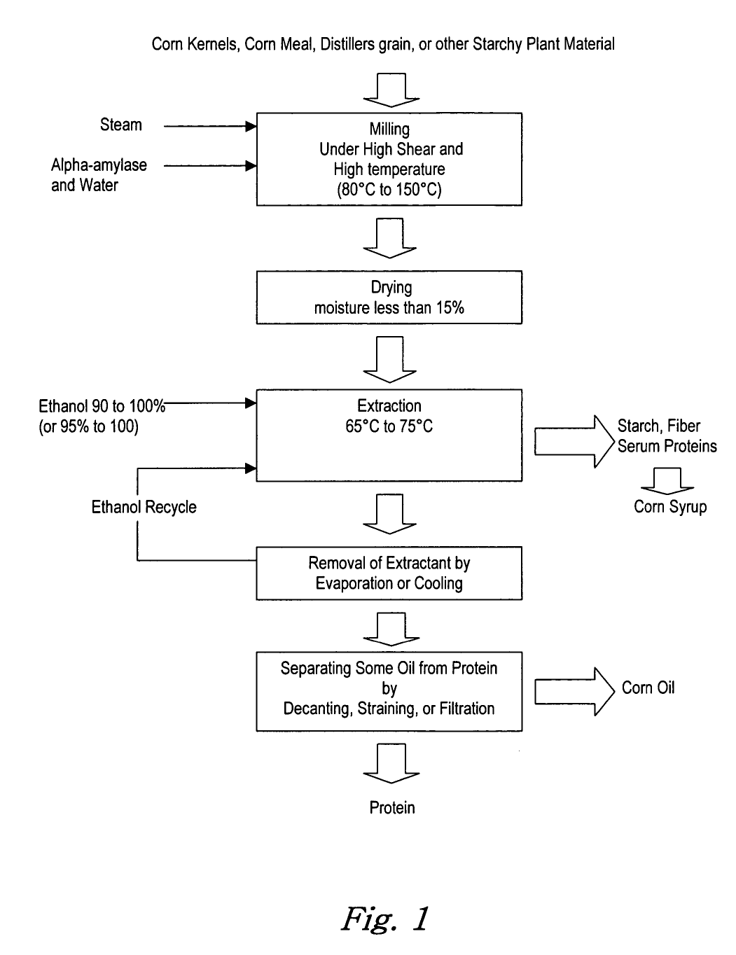

An illustrative embodiment of the invention is shown by the flow chart in FIG. 1. The invention will be described in respect to processing of corn kernels for purposes of illustration only and not limitation. In this embodiment, the corn kernels are cleaned to remove stones and rocks. The corn kernels are then mixed with a liquid, preferably a plasticizer such as water, to achieve a moisture content in the range of about 10 to 70% w/w (w/w is an abbreviation for total weight basis i.e. the mass of the water is 10 to 70% of the total mass of the mixture) of the mixture, preferably with a moisture content in the range of 30 to 55% w/w. The liquid can be comprised of various plasticizers such as water, ethanol, glycerol, and other compounds can be added to obtain various functional properties of the processed material. The amount of the liquid added to the starchy plant material depends on the nature of the plant material.

Additionally, a liquefaction enzyme such as alpha-amylase, which is commercially available from Enzyme Development Corporation, New York, N.Y., in the amount of 1500 units per kilogram can be mixed into the mixture to reduce energy consumption during processing.

The mixture is subjected to elevated temperature (superambient), preferably in a range from about 80° C. to 150° C., and shear force during milling in a high shear processor sufficient to produce a processed material having an increased solubility in alcohol. The high shear processor is of a design that is capable of applying shear force and elevated temperature. For purposes of illustration, a suitable high shear processor comprises a twin screw continuous processor jacketed with high pressure steam and is commercially available from Readco Manufacturing Company, York, Pa. However, the invention is not limited to such equipment and can be practiced using other kinds of high shear processors such as a single screw extruder, kneader, or other equipment capable of producing high shear for processing pursuant to the invention. The operational settings of the processor, such as those provided in the examples 2 and 3, can be determined empirically to achieve the desired results. The shear force provides a thorough mixing of enzyme and starch, while allowing starch hydrolysis in a semisolid state.

After mixing at an elevated temperature and application of shear force, the semi-sold mixture is then dried to a moisture content sufficiently low, such as a moisture content less than 15% w/w. The drying preferably occurs in a high shear processor but may also be accomplished by other conventional methods such as drying in an oven to achieve the desired moisture content. The mixing of the starchy plant material and liquid at elevated temperature to form a mixture, applying shear force to the mixture, and the drying of the mixture can be carried out separately; however, it is preferable to carry out these steps in a single piece of equipment such as a high shear processor.

At the low moisture content, the processed material is then extracted out of the mixture by an extractant such as an alcohol, preferably ethanol. The temperature of the extractant is in a temperature range of about 50° C. to the boiling temperature of the extractant and is preferably in the range of 65° C. to 75° C. Ethanol extractant can be in concentration the range of 90 to 100% w/w ethanol balance water with the preferred concentration in the range of 95 to 98% w/w ethanol basis water. Under these conditions corn zein and corn oil form a complex that is soluble in 95 to 100% w/w ethanol basis water at a temperature above 50° C. This characteristic of the complex makes it possible to quantitatively and simultaneously extract corn oil and protein. For each bushel of corn, approximately 33 lbs of ethanol are required to extract 96% of the corn oil and 95% of the zein. Extraction can be achieved by conventional means one of which is described in example 1.

Alternatively, when the mixture has been dried to a moisture content less than 3% w/w, extraction can occur in the presence of alcohol, preferably 95% to 100% ethanol, while simultaneously dehydrating the alcohol, for example ethanol can be dehydrated to 99.6% w/w.

Some byproducts of the mixture remain after the extraction step. The byproducts comprise starch, fiber, and serum proteins. The starch is partially hydrolyzed when a liquefaction enzyme such as alpha-amylase is added to the mixture at the milling step. The starch can be further converted to corn syrup by additional conventional processing.

The extractant is then removed by conventional means such as cooling or evaporation. Removing the extractant by cooling is described in example 1. Evaporation may be achieved using a rotary evaporator or other conventional equipment. Membrane technology, or other equipment commonly used in the art may also be used to remove the extractant. Furthermore, the evaporated extractant can be recycled for further extractions.

When the extractant is removed, the processed material becomes solid which allows the processed material to be separated from some of the oil. Decanting, straining, filtration, or use of a centrifuge, etc. can be utilized to separate the processed material from some of the oil.

After separating the processed material from some of the oil, the processed material and a solvent, preferably hexane, are contacted to remove any residual oil. Washing, rinsing, or other conventional methods can be used to contact the processed material and the solvent.

The resulting processed material has an increased solubility in alcohol and is thermoplastic in nature. For example, the resulting processed material is soluble in high concentrations of aqueous ethanol above 95% while natural zein dissolves in ethanol only when the ethanol is at a concentration ranging from 60% to 80%. The increased solubility in alcohol allows the material to be extracted simultaneously with oil. Also the resulting material is food grade and can be used for a variety of industrial applications. By increasing the yields of oil extraction and increasing the value of the corn protein, the processing cost of corn and other starchy materials is reduced.

This method embodiment requires only two pieces of equipment: corn handling machinery to clean the incoming corn and a continuous processor, and completely eliminates the need of a jet cooker. It is a low initial capital, low maintenance, and low energy consuming process. Due to the simplicity of the process, the same processing facilities can handle various types of grain allowing the flexibility of choosing the feedstock, depending on the demand and cost of current grain supplies.

The following examples are offered in order to more fully illustrate the invention but are not to be construed as limiting the scope thereof.

### EXAMPLE 1

A two-inch twin-screw high-shear processor (Readco Manufacturing Company, York, Pa.) was used for feasibility studies. A five-inch twin-screw processor also was provided by the Readco Manufacturing Company. Corn kernel and corn gluten meal were processed according to the flow diagram (FIG. 1). For whole corn kernel, two controls were prepared. One set of control samples were processed without addition of alpha-amylase, and the other set of control samples were processed without high temperature but with high shear.

In extraction experiments, 1,000 g of sample was placed in a column (5 cm in diameter, and 65 cm in length) jacketed with hot water at 65° C. to 75° C. After two hours, the temperature of the samples was equilibrated, and 1,300 ml of 95% ethanol was pumped to the top of the column and elution started. Approximately 1,000 ml of eluant was collected, and the rest of the solvent was entrapped in the corn residue. The extractant was cooled to ambient temperature. Upon cooling, corn protein precipitated, and the oil solution and protein were separated. The oil in the protein fraction was further washed with cold ethanol. The washing liquid was combined with oil solution. The yield of corn oil and corn protein were determined after ethanol was evaporated in a vacuum rotary evaporator.

The sample treated with alpha-amylase was extracted with 8% yield and included approximately 4% corn oil and 4% corn protein. The process altered the solubility of protein. At a temperature above 65° C., corn oil and corn protein were extracted simultaneously. The protein concentration in the hot solvent was approximately 4%. The solubility of this processed material was at least 10 times higher than the zein in natural state.

The control samples, without addition of alpha-amylase had approximately 4% yield, including 2.5% of protein and 1.5% of corn oil. The control samples, without application of high temperature in the processor, had further decreased the yield to approximately 2%, including approximately 1% of corn oil and 1% of corn protein.

When corn gluten meal was used as a raw material, alpha-amylase was not used because there was no residual starch. The yield of the treated sample was approximately 25%, including 2.5% corn oil. The residual corn gluten meal retained its original price. In fact, after the removal of zein, the residual corn meal had a more balanced protein /lysine ratio that would be beneficial to animals. In the control sample without application of high temperature, the yield was only 5%.

The extracted protein was thermoplastic in nature. Its melting point was approximately 50° C.

### EXAMPLE 2

Two and a half (2.5) kilogram of corn kernels was mixed with 938 ml of water and 12.5 ml of alpha-amylase (Enzyme Development Corp). The mixture was fed into a two-inch twin screw processor; with 120 rpm of rotation rate. Feed rate was 100 g per minute. The steam pressure in the steam jacket of the processor was 60 psi.

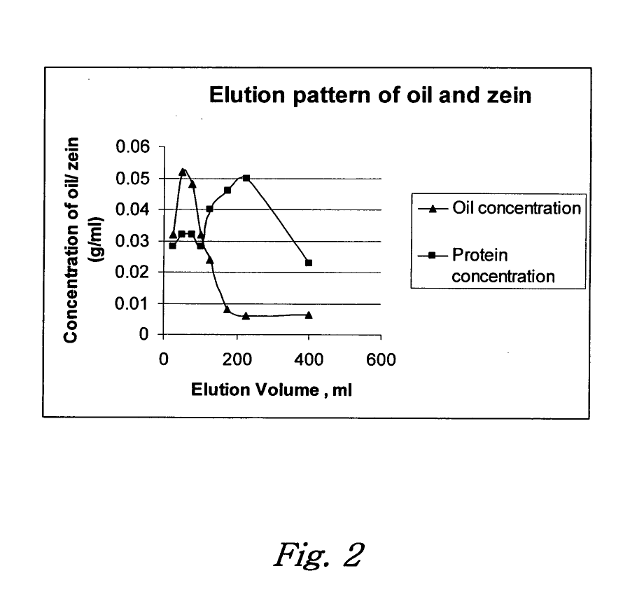

The moisture content of the mixture obtained from the outlet of the processor was 7.5%. Two hundred (200) g of the dry mixture was packed in a column ( 5 cm Diameter). Column temperature is maintained at a temperature at 70° C. Four hundred (400) ml of 95% ethanol was pump to the column with a flow rate of 8 to 10 ml per minute. The eluent was collected in every 25 ml fractions. FIG. 2 shows the concentration of oil and protein in each fraction. The recovery of corn oil was 3.75% of the dry weight, and protein recovery was 5.7% of the total dry weight.

### EXAMPLE 3

One thousand (1,000) g of sorghum was mixed with 200 ml water and 5 ml of alpha-amylase (enzyme Development Corp) and processed as described in Example 1, except that feed rate was 80 g per minute and steam pressure in the steam jacket was 95 psi. Two hundred (200) g of mixture was packed in a column to extract oil and protein as described in Example 1. The results showed that sorghum oil recovery was 3% and protein extraction was 2.0%.

### EXAMPLE 4

To show that the efficiency of this method to solubilize zein is decreased when a liquifaction enzyme is not used the corn kernels were processed under the same condition as described in Example 1, except that alpha-amylase was not added. The results of the extraction showed that the extraction yield of zein and corn oil were 2.5% and 1.5% respectively.

### EXAMPLE 5

Five hundred (500) g of corn gluten meal was mixed with 500 ml of water; alpha-amylase was not used in this experiment. The mixture was processed under the same condition described in Example 1. In the following extraction experiment, the yield of zein was 25% of the total weight of corm meal (dry weight basis), including 2.5% corn oil.

It is to be understood that the invention has been described with respect to certain specific embodiments thereof for purposes of illustration and not limitation. The present invention envisions that modifications, changes, and the like can be made therein without departing from the spirit and scope of the invention as set forth in the following claims.

1. A method of processing a starchy plant material to produce a processed material having an increased solubility in alcohol comprising mixing said starchy plant material and a liquid at an elevated temperature to form a mixture and applying shear force to said mixture to produce said processed material.

2. A method according to claim 1 wherein said processed material comprises protein.

3. A method according to claim 1 wherein said processed material comprises oil and protein.

4. A method according to claim 1 wherein said processed material is thermoplastic.

5. A method according to claim 1 wherein said method also produces an oil.

6. A method according to claim 1 wherein said starchy plant material comprises at least one of corn kernels, corn meals, distillers grain, sorghum, and millet.

7. A method according to claim 1 wherein said liquid is a plasticizer.

8. A method according to claim 1 wherein said liquid comprises at least one of water, ethanol, and glycerol.

9. A method according to claim 1 wherein in said mixing step said liquid is added to a achieve a moisture content in the range of about 10 to 70% w/w of said mixture.

10. A method according to claim 1 further comprises mixing a liquefaction enzyme with said starchy plant material and said liquid.

11. A method according to claim 10 wherein said liquefaction enzyme is alpha-amylase.

12. A method according to claim 1 where said elevated temperature is in a range from about 80° C. to 150° C.

13. A method according to claim 1 further comprising drying said mixture.

14. A method according to claim 13 wherein said mixture is dried to a moisture content less than 15% w/w.

15. A method according to claim 13 wherein said mixing, said applying shear force to said mixture, and said drying occur in a high shear processor.

16. A method according to claim 13 further comprising extracting said processed material from said mixture with an extractant.

17. A method according to claim 16 wherein said extractant is ethanol.

18. A method according to claim 17 wherein said ethanol is 90 to 100% w/w basis water.

19. A method according to claim 16 wherein said extractant is in a temperature range of about 50° C. to boiling temperature of said extractant.

20. A method according to claim 13 further comprising drying said mixture to a moisture content less than 3% w/w, extracting said processed material from said mixture in the presence of alcohol while dehydrating said alcohol.

21. A method according to claim 16 further comprising separating some oil from said processed material.

22. A method according to claim 21 further comprising contacting said processed material and a solvent to remove any residual oil.

23. A method according to claim 16 wherein starch is remains as a byproduct of said extraction and said starch is converted to corn syrup.

24. A method of making a processed material, comprising introducing a starchy plant material and a liquid into a high shear processor for mixing, heating, application of shear force, and drying to produce said processed material that comprises a protein and that has an increased solubility in alcohol.

25. A thermoplastic material that is derived from a starchy plant material and that has increased solubility in alcohol.
